(19) United States
(12) Patent Application Publication
(10) Pub. No.: US 2006/0092467 A1
(43) Pub. Date: May 4, 2006

(54) Print job workflow system

(76) Inventors: Tiberiu Alexandru Dumitrescu, Simi Valley, CA (US); Margareta Vamos, Woodland Hills, CA (US); Alin Petru Irimie, Dunedin, FL (US); Sorin Marghitoiu, Simi Valley, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/300,102

(22) Filed: Dec. 13, 2005

Related U.S. Application Data
(63) Continuation-in-part of application No. 10/932,800, filed on Sep. 1, 2004.

(51) Int. Cl. G06F 3/12

(52) U.S. Cl. 358/1.15

(57) ABSTRACT

There are disclosed print job workflow methods and systems. A method may comprise providing a user interface to allow a user to select one or more workflow elements and to create a current workflow. A workflow element may include processing elements. A user selection of one or more workflow elements may be received as selected workflow elements. User placement of the selected workflow elements to create the current workflow may be recognized. Information about the selected workflow elements included in the current workflow may be received. Verification of the current workflow may be performed. A system may be implemented on a computing device and may cause a print job to be printed on a printing device.

### RELATED APPLICATION INFORMATION

This patent application is a continuation-in-part of U.S. patent application Ser. No. 10/932,800 filed Sep. 1, 2004, which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The invention relates to printers, print jobs, and control of printers and print jobs.

2. Description of the Related Art

Printers are ubiquitous in society. Printers are used in schools, at work, at home, at points of sale, and many other locations. Mass mailings may be created with printers that have features that allow them to handle jobs requiring large volumes of printed matter. Many high volume printers can be controlled by external computers. Many printers are capable of communicating with and receiving print jobs from a computer over a network.

The features and technologies included in printers has been advancing steadily. In some circumstances, when a new printer having new features is acquired, the software and/or print jobs on a controlling computer may not be capable of taking advantage of the new features of the new printer and/or the software and/or print jobs on a controlling computer may need to be upgraded to take advantage of new features of the new printer.

### DESCRIPTION OF THE DRAWINGS

FIG. 1 is a block diagram of an environment in which the print job workflow system described herein may operate.

FIG. 2 is a flowchart of the actions taken by a print job workflow system.

FIG. 3 is a flowchart of the actions taken by a print job workflow system in design mode.

FIG. 4A is a flowchart of the actions taken to receive rules to be used by a conditional processor processing element.

FIG. 4B is a flowchart of the actions taken by a conditional processor processing element.

FIG. 4C is a flowchart of the actions taken by a data replacement processing element.

FIG. 5 is an example screen shot of a user interface provided by a print job workflow system.

FIG. 6 is another example screen shot of a user interface provided by a print job workflow system.

FIG. 7 is a flowchart of the actions taken by a print job workflow system in processing mode.

### DETAILED DESCRIPTION

Throughout this description, the embodiments and examples shown should be considered as exemplars, rather than limitations on the apparatus and methods of the present invention.

A System

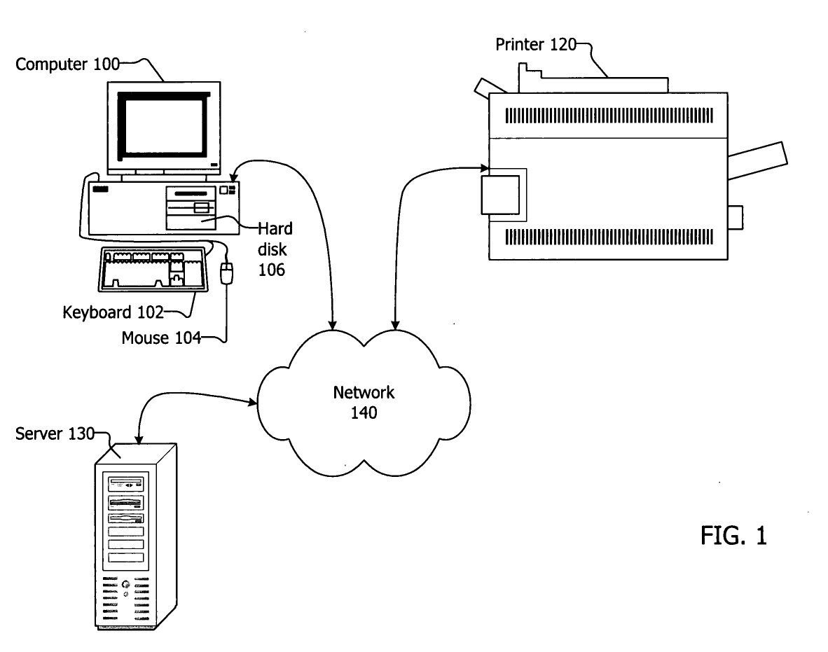

FIG. 1 is a block diagram of an environment in which the print job workflow system described herein may operate. Computer 100, printer 120 and server 130 may communicate over network 140. Although only one computer 100 and one printer 120 are shown, two or more computing devices and two or more printing devices may be coupled with network 140 and incorporated in the methods and systems described herein.

The environment shown includes computer 100 which may be a personal computer or other computing device. The print job workflow system may be implemented with any computing device. A computing device as used herein refers to any device with a processor capable of executing instructions, a communications unit, memory and at least one storage device. A computing device may be, for example, a personal computer, a server computer, a computer workstation, a computing tablet, a portable computer, and a laptop computer. These computing devices may run an operating system, including, for example, variations of the Linux, Unix, MS-DOS, Microsoft Windows, and Apple Mac OS operating systems.

Computer 100 may include a hard disk 106 and/or other storage device, and may have user input devices, such as, for example, keyboard 102 and mouse 104 coupled thereto. Other user input devices such as, for example, track balls and others may be included in addition to and in place of the keyboard 102 and mouse 104.

Although shown as a hard disk 106, the computer 100 may include other storage devices in addition to or in place of hard disk 106. As used herein, a storage device is a device that allows for the reading from and/or writing to a machine readable medium. A storage device may include or be a machine readable medium. A machine readable medium is a medium that includes code, data, instructions or other information which can be read by and/or executed by a processor. A machine readable medium includes, for example, magnetic media (e.g., hard disks, tape, floppy disks), optical media (e.g., compact disk (CD) and digital versatile disk (DVD)), flash memory products (e.g., memory stick, compact flash and others), and volatile and non-volatile silicon memory products (e.g., flash memory, random access memory (RAM), programmable read-only memory (PROM), electronically erasable programmable read-only memory (EEPROM), and others). Example storage devices include hard disk drives, CD drives, DVD drives, flash memory devices, and others.

The print job workflow system may be embodied in software such as one or more of an application program, applets (e.g., a Java applet), a browser plug-in, a COM object, a dynamic linked library (DLL), a script, subroutines, an operating system component or service, or a combination of these and other software components. In one embodiment, the print job workflow system is implemented as application program software stored on hard disk 106 and/or other storage device included in or coupled with computer 100. In this embodiment, the application software may include or access plug-ins or other software components available locally and/or from an external source such as, for example, server 130 or another computing device on network 140.

The computer 100 includes at least one communications unit. The communications unit may be a network interface card (NIC) or other device that allows the personal computer 100 to access other computing devices and/or network capable devices over a network 140, including, for example, server 130 and printer 120. A network capable device is any device that is capable of communicating over a network 140. Network 140 may be a local area network (LAN), a wide area network (WAN), the Internet, a public network, a private network, other network, and a combination thereof. The network 140 may be wired, wireless, or a combination thereof. The network 140 may include or be the Internet and may support Ethernet, the transmission control protocol/internet protocol (TCP/IP), and other communications protocols.

The computer 100 may be directly connected (not shown) to printer 120. In this embodiment, the communications between the computer 100 and the printer may be via a wired connection or a wireless connection, and may be achieved according to a proprietary scheme or a communications standard, such as, for example, Universal Serial Bus (USB), IEEE 1394 (also known as Firewire® and i.link®), Ethernet, IEEE 802.11 (also known as Wi-Fi), IEEE 802.16 (also known as WiMAX), ZigBee, Bluetooth, and others. As such, a communications unit may be a chip or chipset that provides support for one or more wired and/or wireless communications standards.

Printer 120 may be any device capable of printing on paper, card stock, photography paper, plastic, and/or other media, and may be referred to as a printing device. Printer 120 may be network capable and may include a communications unit as described above. In addition, printer 120 may have many or all of the features of a computing device such as, for example, a processor, memory, and one or more storage devices.

Methods

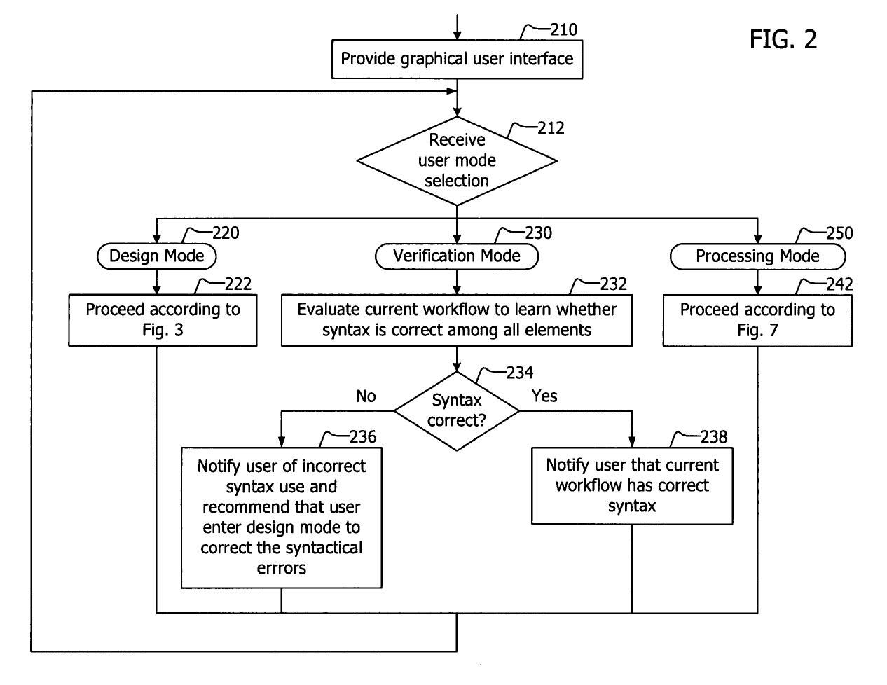

FIG. 2 is a flowchart of the actions taken by a print job workflow system. The print job workflow system may execute a method implemented as software such as, for example, an application program that may be supplemented with one or more plug-in modules that add various features to the print job workflow system. The print job workflow system may allow a user to specify, execute and/or verify a workflow. A workflow defines one or more input information sources, processing to be performed on input information received from the one or more information sources, and one or more output destinations to which output information resulting from the processing is directed. As used herein, the input information sources are referred to as input elements, the processing is performed by processing elements, and the output destinations are referred to as output elements. Each of these elements is referred to as a workflow element. A workflow as used herein refers to an arrangement of workflow elements in which one or more input elements provide input information to one or more processing elements which provide output to one or more output elements. Example input elements, processing elements and output elements are described in more detail below.

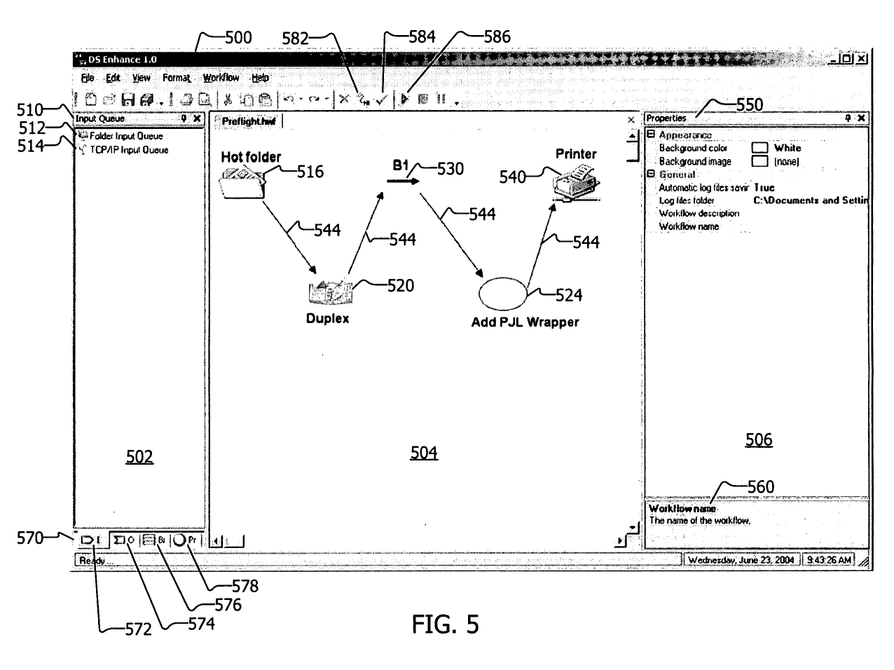

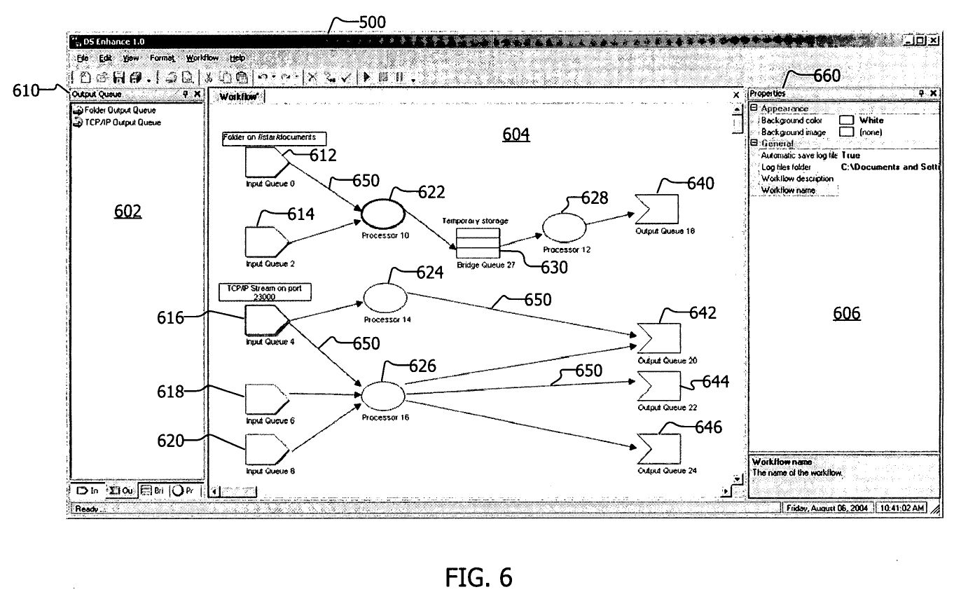

The workflow elements may be arranged to form a workflow. Each of the workflow elements may be graphically represented by a drawing, icon, graphical image or other rendering. Connectors may be used to link the workflow elements into a workflow. The connectors may be implemented graphically as lines representing the flow of information between workflow elements. This is shown in and described below regarding FIGS. 5 and 6. Each of the workflow elements may be arranged in a sequence beginning with an input element and ending with an output element. The workflow may proceed from element to element along the connectors. The workflow may be arranged from left to right, right to left, diagonally, circularly, and in any arrangement desired by a user. There may be one or more input elements at the beginning of a workflow, and some input elements may be located after some processing elements. In addition, a workflow may have multiple destination output elements. As such, a workflow may allow for non-linear arrangement of workflow elements.

The print job workflow system may provide a graphical user interface, as shown in block 210. The print job workflow system may create a user interface using windows, panes, style sheets, frames, forms, and/or other constructs made available by the operating system, desktop metaphor software, and/or provided by the print job workflow system. Various user interface items may be included in the windows, panes or other user interface constructs. The term “user interface items” as used herein includes menus (pull-down, walking, and others), tabs, check boxes, selection circles, text, text entry fields, forms, graphics, icons, sliders, knobs, buttons, and other items. Example graphical user interfaces of a print job workflow system are shown in and described below regarding FIGS. 5 and 6.

The graphical user interface may allow a user to select between two or more modes of the print job workflow system. The modes may include design mode, verification mode and processing mode. In various embodiments, the modes may be presented to a user as tabs of panes, as buttons, as icons, in menus, and other user interface item or construct. The print job workflow system may receive a user mode selection, as shown in block 212.

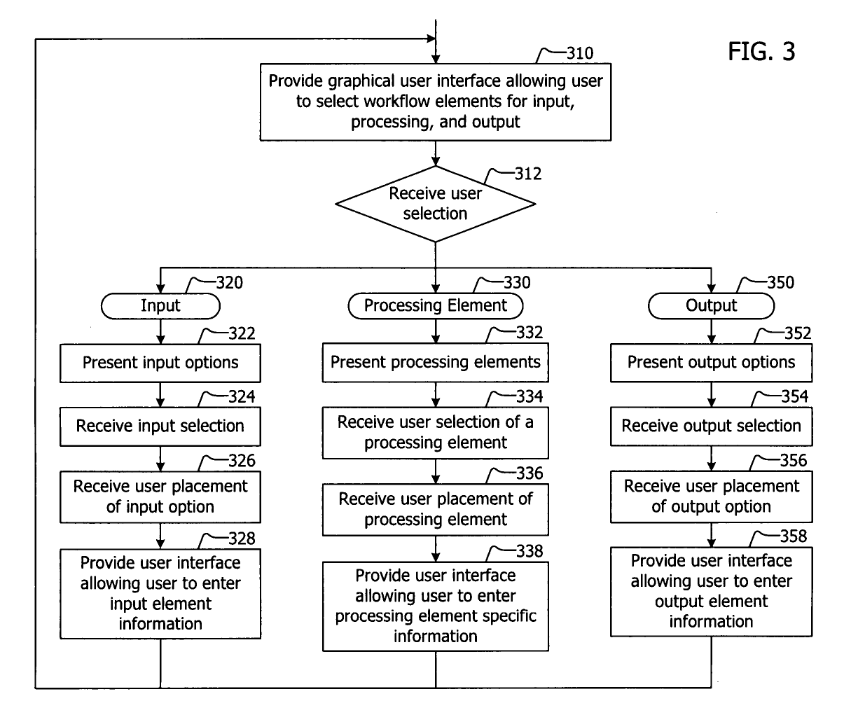

When the user selects design mode, as shown in block 220, the flow of actions continues as discussed below regarding FIG. 3, as shown in block 222.

When the user selects verification mode, as shown in block 230, the print job workflow system evaluates the current workflow to learn whether the syntax is correct among all processing elements. For example, for those processing elements requiring certain kinds of input, the inputs to those processing elements are checked to ensure that they correspond to the input required by the particular processing elements. If the syntax of the workflow is not correct, the print job workflow system notifies the user that incorrect syntax is used in the workflow and may recommend that the user enter design mode to correct the syntactical errors, as shown in block 236. The user may be notified of errors by visual cues such as color change of problem areas in the workflow, flashing of problem areas in the workflow, or by otherwise making the problem areas in the workflow conspicuous to a user. An audible alert may also be issued. The audible alert may, for example, be synthesized or actual recorded human voice, music, sound effect or other sound. If the syntax of the workflow is correct, the print job workflow system may notify the user that the syntax of the current workflow is correct, as shown in block 238. This may be achieved by displaying a text message and/or by displaying a graphical image such as, for example, a big check mark. An audible alert may also be issued.

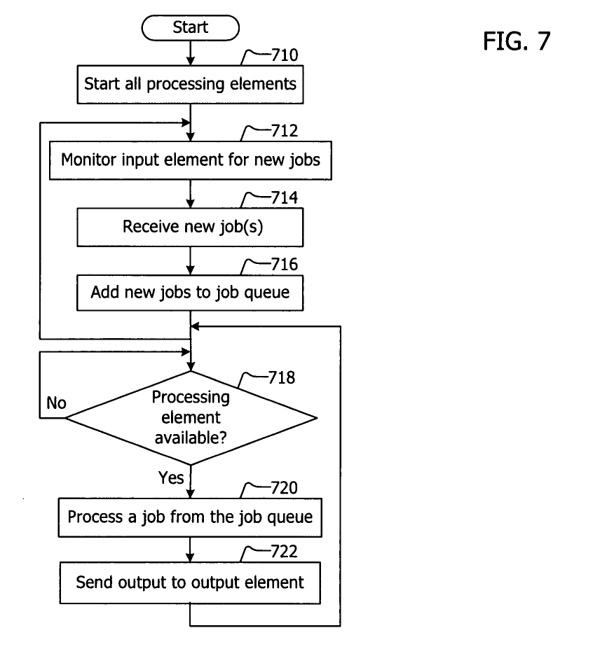

When the user selects processing mode, as shown in block 240, the flow of actions continues as discussed below regarding FIG. 7, as shown in block 242.

The flow of actions after blocks 222, 236, 238 and 242 continues back to block 212.

FIG. 3 is a flowchart of the actions taken by a print job workflow system in design mode. After a user selects design mode, the print job workflow system provides a graphical user interface allowing the user to select workflow elements for input, processing, and output, as shown in block 310. Design mode allows a user to construct a workflow. A workflow may be comprised of user selections of one or more of each of input elements, processing elements and output elements. In one embodiment, bridge elements may also be provided for inclusion in workflows. Workflow elements may be software plug-ins to the print job workflow system in the form of, for example, but not limited to, applets, DLLs or JavaScript. The workflow element plug-ins may be located in a file system folder created by the print job workflow system on a storage device. In one embodiment, there is one plug-in corresponding to each kind of workflow element.

The print job workflow system receives a user selection of a workflow element, as shown in block 312. In one embodiment, workflow elements are presented as tabbed panes. When a tab on a window pane is selected, the available elements for the type of element selected are presented in the pane. In this embodiment, a user may click on or otherwise choose an element and drag it to a current workflow window. In another embodiment, pull-down menus are provided for each of the workflow elements. In this embodiment, each workflow element submenu displays the specific elements for each of the kinds of workflow elements. In this embodiment, an element may be chosen by selecting the element from the submenu and dragged to the current workflow window. Other graphical user interface techniques may also be employed to present the workflow elements.

When the user selects input elements, as shown in block 320, the print job workflow system presents one or more input options to the user, as shown in block 322. In one embodiment, the input elements from which a user may choose are a folder input queue and a network input queue. The network input queue may be a TCP/IP input queue that monitors a TCP/IP port for incoming information or a TWAIN input queue listening to a TWAIN device. TWAIN devices include, for example, scanners and other devices. The format of an input job or data stream may be in a proprietary or well known page description language. Example input job well known formats include Printer Control Language (PCL), Printer Job Language (PJL), PostScript, Hewlett-Packard Graphics Language (HPGL) and Intelligent Printer Data Stream (IPDS), Graphical Device Interface (GDI), Portable Document Format (PDF), and others. An input job may also include or be one or more Joint Photographic Experts Group (JPEG) files, Tagged Image File Format (TIFF) files, and other files. An input job may also be a text file encoded as ASCII, EBCDIC or any other standard or proprietary character encoding.

The print job workflow system receives an input option selection from a user, as shown in block 324. The print job workflow system may receive user placement of the input option into the current workflow window, as shown in block 326. That is, the user drags and drops the input element into a desired location in the current workflow window. In one embodiment, when the user places the input option into the current workflow window, the print job workflow system automatically provides a user interface that allows the user to provide needed information about the input element, as shown in block 328. Such needed information may include a TCP/IP port designation. The user may also at the user's initiative select and edit the properties of the input element when in design mode.

When the user selects processing elements, as shown in block 330, the print job workflow system presents one or more processing elements to the user, as shown in block 332. The number of processing elements supported may vary. Processing elements may be added to the print job workflow system to support new features of a destination printer, new demands of a print job workflow system user, and the characteristics of input print jobs. Example processing elements include: a command addition processing element, a command line utility processing element, a character set conversion processing element, a data replacement processing element, a file copy processing element, a job concatenation processing element, a job splitting processing element, a conditional processor processing element, a sniffer processing element, and a job ticketing enhancing processing element. One or more or all of these processing elements may be provided in a print job workflow system, some of these processing elements may be combined, and additional processing elements may be included in addition to or in place of these example processing elements.

A command addition processing element allows a user to add or modify a command to an existing print job. That is, an existing command may be edited or a new command may be inserted. For example, a command addition processing element may be defined by a user to print a job in duplex. Adding a duplex command is particularly useful if a print job designed for an older printer that does not support duplexing is to be directed to a newer printer that supports duplexing. The duplex specified command addition processing element will edit the print job so that the print job will be printed in duplex rather than simplex. This may be achieved by changing a bit or by changing and/or adding a byte/character sequence. In other circumstances an entire print job language (PJL) header may be stripped and replaced with a new header according to the command and features specified by a user for the command addition processing element.

A command line utility processing element allows a user to supply an executable file that will perform a desired task. The command line utility processing element may be implemented as a plug-in. The command line utility processing element may interpret or compile commands included in a file designated by the user or having a default name. As such, the compiler or interpreter may support one or multiple print job control languages and their associated commands. The command line utility processing element may support proprietary commands. The command line utility processing element may be used to convert a print job or a component thereof from a first format to a second format. The command line utility processing element may execute a third party program to convert features of graphics or images, to manipulate a particular file such as, for example, a PDF file, and to achieve other tasks, such as, for example, format conversion. Format conversion includes, for example, converting from PDF to PostScript, from TIFF to PCL, from JPEG to TIFF, from GIF to TIFF, from RGB (red, green blue) to CMYK (cyan-magenta-yellow-black), and others.

The command line utility processing element may provide legacy support by interpreting or executing an old, existing script. In this way, this processing element is capable of executing, compiling and/or interpreting older style executable or command languages and scripts. This processing element may reduce costs as a new script in a current printer control language need not be written.

A character set conversion processing element allows a user to convert from a first character set to a second character set. For example, a print job may have been created by an IBM computer that stored a job that used the Extended Binary Coded Decimal Interchange Code (EBCDIC) character set. To run the job on a new printer that supports the American Standard Code for Information Interchange (ASCII) character set, this processing element will convert a print job from EBCDIC to ASCII. Other character set conversions may also be written as plug-ins to the print job workflow system to provide support for other character set conversions. A user interface may be provided to allow a user to select the character set conversion processing element and to select the source and/or destination character sets or encodings. In one embodiment, the source character encoding may be auto-sensed by the character set conversion processing element or the print job workflow system, such that the user only need specify the destination character encoding. In one embodiment a destination printing device or system may automatically perform or invoke character set conversion processing when the print job is encoded in a format incompatible with or not optimal for the destination printing device or system.

A data replacement processing element allows a user to replace one group of data with another group of data. This may allow a user to change a name, address, time, date, commands or other information. The searched for and replacement data may be specified by a user. The data may be entered as regular text and/or by ASCII code, or other character encoding scheme.

A file copy processing element allows a user to move or copy a file from a first location to a second location. The first and second locations may be local and/or remote to the computing device executing the print job workflow software. The user may specify the file locations via a user interface provided by the file copy processing element.

A job concatenation processing element allows a user to concatenate two or more jobs or data streams into one. By using this processing element, efficiency is increased as down time and/or restart time incurred between jobs is removed. The user may concatenate specified jobs, and/or the print job workflow system may automatically recommend which jobs should be concatenated.

A job splitting processing element allows a user split one job into multiple jobs. A job exceeding a certain user or system specified page length or size may be broken up into two or more sequential jobs. Size may refer to the memory used by a print job or the number of lines in a print job. In one embodiment, the maximum length or size of a job may be based on the capabilities of a destination printer. For example, a hard drive or memory size of a printer may limit the length or size of a job. In various embodiments, a user may specify the length or size limit of a job, or the job splitting processing element may recommend a job length or size limit based on a printer specified as part of the workflow.

A job distribution processing element may be provided to automatically split jobs into multiple jobs and distribute them according to characteristics of available destination devices, such as, for example, printers. In one example job distribution element, print jobs may be split and distributed according to the destination printer's capabilities. For example the job distribution element may check whether a page includes color or black and white elements. In this way, color pages of a print job may be sent to a printer that efficiently handles color printing while black and white pages or jobs are sent to a printer that efficiently handles black and white printing. In another example, the job distribution element may evaluate the finishing options of the print job. Finishing options include, for example, binding, stapling, folding, and others. In this way, the job distribution element may distribute the job to a destination device that supports the finishing options.

An additional processing element may be referred to as a conditional processor processing element. The conditional processor may provide a user interface that allows a user to specify one or more conditions or rules. When a condition or rule is met, a certain user specified action is taken. Example conditions and rules may include time of day when the print job is received, day of the week when the print job is received, keywords included in the print job, data associated with or included in the job, file type(s) included in the print job, file type data telltales, key word(s) included in the print job name, size of the job (for example, measured in kilobytes or megabytes), number of pages in the job, and information included in the job about a preferred or specified printer or a specified destination, including but not limited to printer characteristics, printer capabilities, printer brand, printer model, printer name, IP address. In one embodiment the conditional processor processing element may run an external application on the job and use a return code to determine if the job meets the particular condition. One or more of these rules may be executed for one or more jobs, on all jobs or on specified job. One rule or condition may be a pre-screening conditional processor which evaluates certain characteristics of a print job to learn which rules should be processed and to which printer or printers the job should be directed. This is similar to a sniffer processing element described below. Each of the rules or conditions may be implemented as a plug-in, DLL, applet, module or other software component to the conditional processor processing element software or the print job workflow system software. The conditional processors may have more than one output and can send jobs to one or more of its outputs.

Another processing element may be referred to as a sniffer processing element. In one embodiment, the sniffer processing element operates independent of other processing elements. In another embodiment the sniffer processing element is implemented as a plug-in to the conditional processor. The sniffer processing element may examine or otherwise evaluate the contents of, characteristics of, and/or meta data or other information concerning or included in a print job to determine the kind of content included in the print job. Based on the kind of content, a conditional processor processing element or rule included in the sniffer may direct the print job or portions of the print job to printing devices that are most suited to the content evaluated. In one embodiment, the sniffer processor may iteratively seek information in expected or well known locations in a print job file to evaluate the kind of file or requirements of the print job. For example, postscript jobs typically start with “!%PS”, PDF jobs typically start with “%PDF”, and TIFF jobs start with “MM” or “II”. More complicated sniffing can be done. For example, parsing of a portion of the internal structure of a TIFF file may allow the sniffer to distinguish between files that accidentally start with “MM” and real TIFF files. Based on the information gleaned from the sniffing performed by the sniffer processing element, the sniffer processing element may evaluate which to which of a group of available printers the print job or portions of a print job may be directed.

Yet another processing element may be a job ticketing enhancing processing element. The job ticketing enhancing processing element may allow for the rejuvenating of old print jobs, such as, for example jobs in the PDL format that were created 15, 20, 25 years ago, etc. The job ticketing enhancing processing element may be performed automatically and/or may involve user input. For example, an old print job that had printing features or qualities that were dedicated to an older printer that is no longer being used may be enhanced to conform to the new or modified commands for the feature or quality available in more modem printers. The features and qualities that may be enhanced are those that are available in current printers but were not available or were different at the time of creation of the print job. The features and qualities that may be enhanced may include collation, stapling, binding, resolution, number of pages per sheet, duplex, booklet creation, water marking, headers, footers, page numbering, and others. The job ticketing enhancing processing element may function automatically or may require user input, or both depending on the particular print job feature or quality.

For example, with regard to resolution, if the job ticketing enhancing processing element detects an old print job at 100 dpi, it may automatically be converted to 300 dpi or 1,200 dpi. In another example, the job ticketing enhancing processing element may seek user input regarding the resolution, such as by requesting the user to select a desired resolution for all pages, for black and white page, and/or for colored pages. The list of resolutions provided may correspond to the printing resolution of the printers included with or accessible to the print job control system, and may include, for example, 300 dpi, 600 dpi, 1,200 dpi, 2,400 dpi, 4,800 dpi, 9,600 dpi, etc.

Referring again to FIG. 3, the print job workflow system receives a user selection of a processing element from a user, as shown in block 334. The print job workflow system may receive user placement of the processing element into the current workflow window, as shown in block 336. That is, the user drags and drops the processing element into a desired location in the current workflow window. When the user places the processing element into the current workflow window, the print job workflow system may provide a user interface allowing the user to enter processing element specific information, as shown in block 338. The required processing element specific information varies among the different processing elements. The user may also at the user's initiative select and edit the properties of the processing element when in design mode.

When the user selects output elements, as shown in block 340, the print job workflow system presents one or more output options to the user, as shown in block 342. In one embodiment, the output elements from which a user may choose are a folder output queue and a network output queue. The network output queue may be, for example, a TCP/IP output queue that sends outgoing information through a specified TCP/IP port. Output may be sent to a printer via a network output queue such as a TCP/IP output queue. Other output queues are also possible. The print job workflow system receives an output option selection from a user, as shown in block 344. The print job workflow system may receive user placement of the output option into the current workflow window, as shown in block 346. That is, the user drags and drops the output option into a desired location in the current workflow window. In one embodiment, when the user places the output element into the current workflow window, the print job workflow system automatically provides a user interface that allows the user to provide needed information about the output element, as shown in block 348. Such needed information may include a TCP/IP port designation of a network output queue or a folder location of a folder output queue. The user may at the user's initiative select and edit the properties of the output element when in design mode.

In another embodiment, the user may also select a bridge element to be placed between processing elements. The bridge element may be used to transfer information between processing elements. The bridge element may be a queue that can receive and send data in any of various formats, so long as the data sent between the processing elements can be processed by each of the processing elements. Bridge elements may support data transfer via a file supported by the operating system. The file may be stored on a hard drive or other storage device, and may be available to another application program or other software entity. Bridge elements may support data transfer via a stream supported by the operating system. Streams do not permanently store data on a hard drive or other storage device. Bridge elements may support data transfer via proprietary data format so long as the processing elements know what the internal structure of the data is or that they do not care.

In some embodiments, the print job workflow system may provide support for line printer (LPR) client and/or server functionality such as that provided, for example, in Unix and Microsoft Windows. The LPR functionality may be used in a workflow as an input element which may be referred to as an LPR input queue and/or as an output element which may be referred to as an LPR output queue. An LPR input queue may behave as a limited LPR server. The LPR input queue may accept LPR connections, and receive and spool print job data before passing the print job to a processing element. The LPR output queue may act like a limited LPR client. The LPR output queue may send jobs to an LPR printer or other LPR server. The LPR output queue provides at least minimal support for the Unix and/or Microsoft Windows LPR protocols.

In some embodiments, the print job workflow system may provide support for Microsoft Windows Printer (MWP) functionality. The MWP functionality may support use in workflows as an input element which may be referred to as an MWP input queue and/or as an output element which may be referred to as an MWP output queue. The MWP input queue may allow for receipt of print jobs produced by the Microsoft Windows print spooler. The MWP output queue may place print jobs in a Microsoft Windows printer spooler queue. The Microsoft Windows spooler via the Microsoft Windows print spooler DLL then sends the print job to the appropriate Microsoft Windows output device.

The flow of actions after blocks 326, 338 and 346 returns to block 310.

In this way, as shown in FIG. 3, the user may construct a workflow from the elements provided by the graphical user interface of the print job workflow system when in design mode.

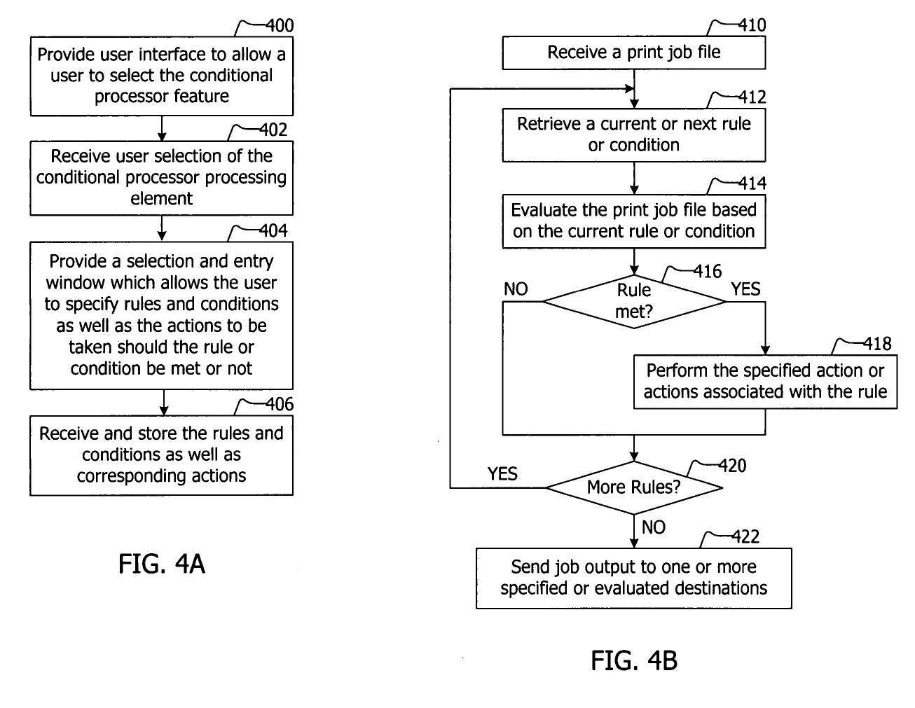

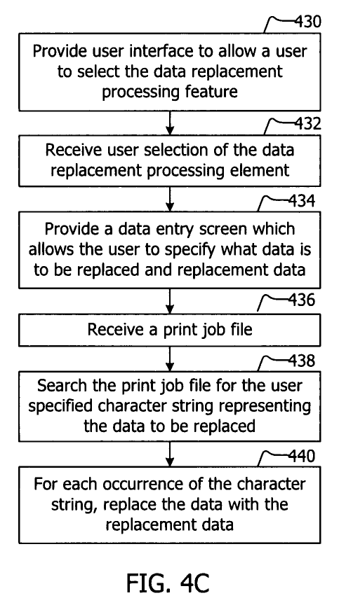

FIG. 4A is a flowchart of the actions taken to receive rules to be used by a conditional processor processing element. As set forth above in para. [49] a user may specify rules and resulting actions to be taken if a rule is met or not met. A user interface may be provided to allow a user to select the conditional processor feature, as shown in block 400. After a user selection of the conditional processor processing element is received, as shown in block 402, the user is provided a selection and entry window which allows the user to specify rules and conditions as well as the actions to be taken should the rule or condition be met or not, as shown in block 404. The user interface for the selection and entry window may use one or multiple user interface techniques that include multiple user interface items. The user specified rules and conditions as well as corresponding actions may be received and stored, as shown in block 406.

FIG. 4B is a flowchart of the actions taken by a conditional processor processing element. A print job file is received, as shown in block 410. A current rule or condition is retrieved, as shown in block 412. The rules may have been provided according the method described regarding FIG. 4A. The print job file is evaluated based on the current rule or condition, as shown in block 414. If the rule is met, as shown in block 416, the specified action or actions associated with the rule are performed, as shown in block 418. A check may be made to determine whether further rules and actions exist, as shown in block 420. If there are additional rules, the flow of actions may continue with block 412 where the next rule is obtained. When there are no further rules to evaluate, the flow of actions continues with sending job output to one or more specified or evaluated destinations, as shown in block 422. The destination may be a printing device, a storage device, a print job processing system, and others.

FIG. 4C is a flowchart of the actions taken by a data replacement processing element. As described above in para. [44], a data replacement processing element allows for replacement of one group of data with another group of data. A user interface may be provided to allow a user to select the data replacement processing feature, as shown in block 430. After a user selection of the data replacement processing element is received, as shown in block 432, the user is provided a data entry screen which allows the user to specify both what data is to be replaced and the replacement data, as shown in block 434. To assist in the accurate replacement of the data to be replaced, the user interface may also all a user to specify that certain neighboring text or characters immediately precede or follow the appearance of data to be replaced for the data replacement to occur. The data replacement processing element may be particularly useful when a company changes names, logos, addresses, and the like, when personnel change, and in other situations. This processing element may also be used to correct or update embedded codes or instructions that may have been included in print jobs prepared for legacy printing systems.

After the data replacement processing element has been specified, a print job file is received, as shown in block 436. The print job file may be searched for the user specified character string representing the data to be replaced, as shown in block 438. For each occurrence of the character string, the data to be replaced is replaced with the replacement data, as shown in block 440. In one embodiment, multiple strings of data may be searched for concurrently or in sequence and replaced by corresponding replacement data.

FIG. 5 is an example screen shot of a user interface provided by a print job workflow system. In this example screenshot, a main window 500 is broken into three areas or sub-windows. A first sub-window 502 displays all available workflow elements to a user, a second sub-window 504 displays the current workflow, and a third sub-window 506 displays the properties of a currently selected element from the current workflow.

In first sub-window 502, four tabbed panes are provided, one each for each of the four kinds of workflow elements supported in this embodiment. Other embodiments may support more or fewer workflow elements. Sub-window 502 includes tabs 570, which when selected display all of the particular kind of workflow element. In this example, tabs 570 include tabbed pane 572 which displays input elements, tabbed pane 574 which displays processing elements, tabbed pane 576 which displays bridge elements, and tabbed pane 578 which displays output elements. The name of the selected workflow element tabbed pane may be displayed as text 510. Each kind of processing element may have a corresponding icon or graphical representation associated with it. In one embodiment, the icons associated either with a particular kind of processing element, or a specific processing element may be user customizable or selectable.

In the example shown, input element tabbed pane 572 displays two available input elements, folder input queue 512 and TCP/IP input queue 514. A specific instance of a folder input queue 512 is shown in the current workflow sub-window 504 as “hot folder” 516.

The second sub-window 504 displays the current workflow. If in design mode, a user may drag and drop workflow elements from the tabbed sub-panes of first sub-window 502 into sub-window 504 to create a workflow. The sample workflow shown in sub-window 504 begins with an input element, hot folder 516. The hot folder may be a shared folder that may receive a print job from a local program or an external source such as remotely network connected computing device. The hot folder 516 is connected with connector 544 to duplex processing element 520. When a print job is received in the hot folder, the duplex processing element 520 performs an action on the print job. In the embodiment shown, a bridge queue B1 530 is placed between duplex processing element 520 and “add PJL wrapper” processing element 524. The duplex processing element 520 is connected with connector 544 to add PJL wrapper” processing element 524. When “add PJL wrapper” processing element 524 finishes processing a particular print job, its output is directed to an output element, in the example, printer 540 through connector 544.

Although not shown in this example, a workflow may have multiple input elements and multiple output elements. This allows for the receipt and processing of multiple print jobs to multiple printers and/or other output devices.

The third sub-window 506 displays the properties of and allows a user to edit the properties of a selected element from the current workflow, or general workflow properties if no element is selected. In this example, the properties 550 are general workflow properties for the appearance and general characteristics of the current workflow. The name of the current workflow may be listed in the third sub-window as text 560.

In addition to the three sub-windows described above, in window 500, the user may select from buttons to enter a particular mode of the print job workflow system. This example allows for three modes which may be entered or started by selecting or otherwise activating an appropriate button. A design mode button 582 is provided to allow a user to enter into design mode to create, or edit a workflow. A verification mode button 584 is provided to allow a user to verify that a current workflow or specified workflow is syntactically correct and will execute without error. A start button 586 is provided to allow a user to enter processing mode and run a current or specified workflow. Although buttons are shown, other activatable graphical user interface items may be used.

FIG. 6 is another example screen shot of a user interface provided by a print job workflow system. The window 600 is similar to window 500 described above, having three sub-windows: workflow element sub-window 602, a current workflow sub-window 604, and properties sub-window 606. As shown, the output element tabbed sub-window 610 is selected in the workflow element sub-window 602. However, the workflow shown has multiple input elements and multiple output elements, and uses representations for the elements different from those shown in FIG. 4. In this example workflow, input elements 612 and 614 provide print jobs to processing element 622 via connectors 650, input element 616 provides input to processing element 624 via connectors 650, and input elements 616, 618 and 620 provide input to processing element 626 via connectors 650.

The result of the processing performed by processing element 622 is stored in a bridge queue 630 which serves as temporary storage. From bridge queue 630, the print job is passed via a connector to processing element 628. When processing element has completed its processing, the print job is sent to output element 640.

Output element 642 receives the results of processing element 624 and 626. Output elements 644 and 646 both receive the result of processing element 626 via connectors 650.

The properties sub-window 606 may show the properties 660 for a currently selected element of the workflow or general properties for the workflow or display thereof.

FIG. 7 is a flowchart of the actions taken by a print job workflow system in processing mode. When a user selects processing mode in the graphical user interface provided by the print job workflow system, all processing elements are started, as shown in block 710. Input elements are monitored for new job, as shown in block 712. This may be achieved by monitoring one or more specified input queues. As described above, the input queues may be, in one embodiment, folder input queues and network input queues. When new jobs are received, as shown in block 714, the jobs may be added to an internal job queue, as shown in block 716. A check is then made to evaluate whether a processing element associated with the input element is available, as shown in block 718. If a processing element is not available, the job may wait a system defined period of time and check again, as shown in block 718. While waiting for a processing element, job data may be stored in a temporary location, such as, for example, a storage device. When a processing element is or becomes available, a job from the job queue is processed, as shown in block 720. Output from a processing element is directed to one or more specified output elements, as shown in block 722. The output elements may be files, printers, or other output elements.

With regard to FIGS. 2, 3, 4 and 7, additional and fewer steps may be taken, and the steps as shown may be combined or further refined to achieve the methods described herein.

Although exemplary embodiments of the present invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

It is claimed:

1. A method comprising:
providing a user interface to allow a user to select one or more workflow elements to create a current workflow
receiving a user selection of one or more workflow elements as selected workflow elements, wherein the workflow elements include processing elements, and wherein the processing elements include at least one or more from the group comprising a conditional processor processing element, a sniffer processing element, and a job ticketing enhancing processing element
recognizing user placement of the selected workflow elements in a current workflow
receiving information about the selected workflow elements included in the current workflow.

2. The method of claim 1 further comprising:
verifying the current workflow.

3. The method of claim 1 wherein the workflow elements further include bridge elements.

4. The method of claim 1 wherein the workflow elements are implemented as software plug-ins.

5. The method of claim 1 wherein the workflow elements further include input elements and output elements.

6. The method of claim 4 wherein the input elements include one or more from the group comprising folder input queues and network input queues, LPR input queue.

7. The method of claim 4 wherein the output elements include one or more from the group comprising network output queues, folder output queues, line printer (LPR) output queues and Microsoft Windows Printer (MWP) output queues.

8. The method of claim 1 wherein the processing elements further include one or more from the group including a command addition processing element, a command line utility processing element, a character set conversion processing element, a data replacement processing element, a file copy processing element, a job concatenation processing element, and a job splitting processing element.

9. The method of claim 1
wherein the user interface further allows the user to select between a design mode, a verification mode and an execution mode; and
wherein the method further comprises receiving a user selection of the design mode, the verification mode and the execution mode.

10. A method comprising:
providing a user interface including a workflow element selection area, a current workflow area, and a control area
receiving a user selection of one or more selected workflow elements from the workflow element selection area, wherein the workflow element selection area includes a processing element pane displaying one or more processing elements, and wherein the processing elements include at least one selected from the group including a conditional processor processing element, a sniffer processing element, and a job ticketing enhancing processing element
recognizing user placement of the selected workflow elements in a current workflow in the current workflow area
receiving information about the workflow elements included in the current workflow.

11. The method of claim 10 wherein the control area allows a user to select between a design mode, a verification mode and an execution mode.

12. The method of claim 10 further comprising:
verifying the current workflow.

13. The method of claim 10 further comprising:
receiving user selection of a mode from the control area.

14. The method of claim 13 wherein the mode comprises a design mode, a verification mode and an execution mode.

15. The method of claim 10 wherein the workflow element selection area further includes an input element pane displaying one or more input elements and an output element pane displaying one or more output elements.

16. The method of claim 15 wherein the workflow element selection area further includes a bridge element pane displaying one or more bridge elements.

17. The method of claim 15 wherein the input elements include one or more from the group comprising folder input queues, network input queues and line printer (LPR) input queues.

18. The method of claim 15 wherein the output elements include one or more from the group comprising network output queues and folder output queues, line printer (LPR) output queues, and Microsoft Windows Printer output queues.

19. The method of claim 10 wherein the processing elements further include one or more from the group including a command addition processing element, a command line utility processing element, a character set conversion processing element, a data replacement processing element, a file copy processing element, a job concatenation processing element, and a job splitting processing element.

20. A machine readable medium having instructions stored thereon which when executed cause a system to perform actions comprising:
providing a user interface to allow a user to select one or more workflow elements and to create a current workflow
receiving a user selection of one or more workflow elements as selected workflow elements
recognizing user placement of the selected workflow elements to create the current workflow
receiving information about the selected workflow elements included in the current workflow.

21. The machine readable medium of claim 20 having further instructions stored thereon which when executed cause the system to perform actions comprising:
verifying the current workflow.

22. The machine readable medium of claim 20 wherein the workflow elements include input elements, processing elements, and output elements.

23. The machine readable medium of claim 22 wherein the workflow elements further include bridge elements.

24. The machine readable medium of claim 22 wherein the input elements include one or more from the group comprising folder input queues, network input queues and line printer (LPR) input queues.

25. The machine readable medium of claim 22 wherein the output elements include one or more from the group comprising network output queues, folder output queues, line printer (LPR) output queues and Microsoft Windows Printer (MWP) output queues.

26. The machine readable medium of claim 22 wherein the processing elements include one or more from the group comprising a command addition processing element, a command line utility processing element, a character set conversion processing element, a data replacement processing element, a file copy processing element, a job concatenation processing element, and a job splitting processing element.

27. A system comprising:
a printing device and a computing device, the computing device and the printing device coupled with one another for communication, the computing device having a processor, a memory and a storage device, the storage device having instructions stored thereon which when executed cause the system to perform actions including
providing a user interface to allow a user to select one or more workflow elements and to create a current workflow
receiving a user selection of one or more workflow elements as selected workflow elements, wherein the workflow elements include processing elements, and wherein the processing elements include one or more from the group comprising a conditional processor processing element, a sniffer processing element, and a job ticketing enhancing processing element
recognizing user placement of the selected workflow elements to create the current workflow
receiving information about the selected workflow elements included in the current workflow
executing the current workflow causing a print job to be printed on the printing device.

28. The system of claim 27 wherein the storage device has further instructions stored thereon which cause the system to perform further operations including:
verifying the current workflow.

29. The system of claim 27 wherein the workflow elements are implemented as software plug-ins.

30. The system of claim 27 wherein the workflow elements further include input elements and output elements.

31. The system of claim 29 wherein the workflow elements further include bridge elements.

32. The system of claim 29 wherein the input elements include one or more from the group comprising network input queues, folder input queues and line printer (LPR) input queues.

33. The system of claim 27 wherein the output elements further include one or more from the group comprising network output queues, folder output queues, line printer (LPR) output queues and Microsoft Windows Printer (MWP) output queues.

34. The system of claim 29 wherein the processing elements further include one or more from the group comprising a command addition processing element, a command line utility processing element, a character set conversion processing element, a data replacement processing element, a file copy processing element, a job concatenation processing element, and a job splitting processing element.

35. The system of claim 27 wherein the user interface further allows the user to select between a design mode, a verification mode and an execution mode.

36. A computing device comprising at least one processor, a memory and at least one storage device, the storage device having instructions stored thereon which when executed cause the computing device to perform actions including:
providing a user interface to allow a user to select one or more workflow elements and to create a current workflow;
receiving a user selection of one or more workflow elements as selected workflow elements, the workflow elements including processing elements, the processing elements including one or more from the group comprising a conditional processor processing element, a sniffer processing element, and a job ticketing enhancing processing element;
recognizing user placement of the selected workflow elements to create the current workflow;
receiving information about the selected workflow elements included in the current workflow;
executing the current workflow, the executing causing a print job to be one or more of
stored on the computing device,
communicated from a first computing device to a second computing device, and/or
printed on one or more printing devices.

37. The system of claim 36 wherein the storage device has further instructions stored thereon which cause the system to perform further operations including:
verifying the current workflow.

38. The system of claim 36 wherein the processing elements are implemented as software plug-ins.

39. The system of claim 36 wherein the workflow elements are implemented as software plug-ins.

40. The system of claim 36 wherein the workflow elements further include input elements, and output elements.

41. The system of claim 38 wherein the workflow elements further include bridge elements.

42. The system of claim 38 wherein the input elements include one or more from the group comprising network input queues, folder input queues and line printer (LPR) input queues.

43. The system of claim 38 wherein the output elements include one or more from the group comprising network output queues and folder output queues, line printer (LPR) output queues and Microsoft Windows Printer (MWP) output queues.

44. The system of claim 36 wherein the processing elements further include one or more from the group comprising a command addition processing element, a command line utility processing element, a character set conversion processing element, a data replacement processing element, a file copy processing element, a job concatenation processing element, and a job splitting processing element.

45. The system of claim 36 wherein the user interface further allows the user to select between a design mode, a verification mode and an execution mode.
